(19) United States
(12) Patent Application Publication
(10) Pub. No.: US 2020/0169108 A1
(43) Pub. Date: May 28, 2020

(54) A BATTERY CONTROL SYSTEM, AND A BATTERY SYSTEM AND SOLAR POWER SYSTEM USING THE CONTROL SYSTEM

(71) Applicant: SIGNIFY HOLDING B.V., EINDHOVEN (NL)

(72) Inventors: Goutam MAJI, EINDHOVEN (NL); Priya Ranjan MISHRA, EINDHOVEN (NL)

(21) Appl. No.: 16/617,309

(22) PCT Filed: May 28, 2018
(86) PCT No.: PCT/EP2018/063872

§ 371 Date: Nov. 26, 2019

(30) Foreign Application Priority Data
May 29, 2017 (IN) 201741018756
Aug. 11, 2017 (EP) 17185972.1

(51) Int. Cl. H02J 7/00; H01M 10/46; H01M 10/6565; H02J 7/35

(52) U.S. Cl. CPC H02J 7/007194; H01M 10/465; H02J 7/0019; H02J 7/35; H01M 10/6565

(57) ABSTRACT

A battery control system is used with a battery, and has a converter to charge and/or discharge the battery. The converter is thermally coupled to the battery, and the temperature of the battery is sensed. A control circuit is provided for controlling the efficiency or power loss of the converter according to the temperature of the battery sensed by the sensor, thereby to alter the level of thermal heat generation, and in turn, transfer from the converter to the battery. In this way, the battery temperature is controlled so that the life time of the battery can be extended. It makes use of the existing converter to deliver thermal energy, so that a separate heater is avoided.

### FIELD OF THE INVENTION

This invention relates to battery control systems, such as circuits which control the charging and discharging of rechargeable batteries.

### BACKGROUND OF THE INVENTION

Rechargeable batteries are used in numerous applications. They are for example used as temporary energy storage devices in systems having time-varying power output and time-varying energy input. For example, lighting luminaires are increasingly being provided with integrated batteries. These are charged by solar energy, which is typically available when the lighting is not needed, whereas lighting is needed when the solar energy is not available. Thus, they function as energy storage elements to account for the time delay between the availability of energy for charging and the requirement for output power.

Particularly for outdoor luminaires, but more generally for outdoor systems, the battery will generally be exposed to the ambient temperature.

The performance of rechargeable batteries such as lithium-ion (LiFePo4) batteries depends on stress parameters such as the maximum charging voltage per cell, the charge and discharge currents, the depth of discharge (DOD) and the battery operating temperature during its course of usage. The cycle life of the battery reduces as the charge and discharge currents, DOD and maximum charging voltage per cell increase. The operating temperature of the battery also shows a considerable impact on life, if battery is operating other than room temperatures.

For example, low temperature battery charging (e.g. less than 10 degrees Celsius) significantly affects the battery cycle life. It has been seen from experiment that if a LiFePo4 cycles at 25 degrees Celsius and offers a life time of 5500 cycles, then if the same battery is cycled at 10 degrees Celsius, it will offer 3750 cycles, and if the same battery is cycled at −10 degrees Celsius, it will offer only 146 cycles.

The table below shows the number of cycles N_{f} of the battery life time at different temperatures (with 100% depth of charge).

| Temperature | N_{f} |
|---|---|
| −10° C. | 146 ± 15 |
| 10° C. | 3750 ± 60 |
| 25° C. | 5550 ± 500 |
| 35° C. | 4930 ± 1000 |
| 50° C. | 1950 ± 350 |

In the case of outdoor luminaires with integrated batteries, the battery will experience extremely low temperatures in many regions. Even for interior luminaires for example for office spaces, the battery will be placed above the luminaire and hence in a less insulated part of a building. Again, the battery may experience extremely low temperatures.

It would be possible to provide a heater to enable the battery to be kept at a desired temperature. However, this is wasteful of power and requires additional hardware. There is therefore a need for to improve the battery life time for a rechargeable battery which is exposed to low temperatures, but without wasting additional power.

In the field of electrical vehicles, there is technology that circulates the heat generated by a converter of the battery to heat the battery.

US 20100050676A1 discloses a cooling system in which an inverter device can change its switching operation in a switching element to increase the power loss and to heat a cooling water.

### SUMMARY OF THE INVENTION

The drawback of known systems is that the heat generation of the converter of the battery is not actively controlled. Thus it is not easy to fine tune/regulate the temperature of the battery flexibly.

The invention is defined by the claims.

It is a concept of the invention to maintain the battery temperature within a range suitable for battery charging/discharging, by changing the efficiency or power loss of the battery's converter to actively regulate the heat generation of the converter. This changing may be further under a premise that the required electrical input or output power of the battery is maintained. Changing the efficiency or power loss of the converter can be implemented for example by modifying the settings of the converter. These settings may further for example comprise frequency, voltage conversion ratio, or battery configuration.

According to examples in accordance with an aspect of the invention, there is provided a battery control system to be used with a battery comprising:

a converter to charge and/or discharge the battery, wherein the converter is adapted to thermally couple to the battery; and

a sensor to sense the temperature of the battery,

wherein the system further comprises a control circuit to control the efficiency or power loss of the converter according to the temperature of the battery sensed by the sensor, thereby to alter the level of thermal heat generation, and in turn, transfer from the converter to the battery.

This system controls the temperature of a battery by actively controlling the heat generation, and in turn, transfer from a converter. Thus, by selectively operating the converter in more or less efficient modes, the thermal generation, and in turn, transfer to the battery may be regulated. By maintaining the battery at a suitable temperature in particular during charging, the life time (in terms of the number of charging cycles) may be improved.

The battery life time is for example extended by maintaining the temperature in a desired band such as 10 degrees Celsius to 35 degrees Celsius, or 15 degrees Celsius to 35 degrees Celsius. The most suitable temperature for battery charging for certain lithium-ion batteries is for example 23 to 25 degrees Celsius.

Preferably, the control circuit is used to control the efficiency or power loss of the converter with the premise of: maintaining an input power of the converter when charging the battery; or maintaining an output power of the converter when discharging the battery. For example, when charging the battery from a solar panel, the input power of the converter is maintained at the maximum power point of the solar panel thus the solar energy is best utilized. When discharging the battery to a load, the output power of the converter to the load the maintained such that the load is driven in a stable way.

The converter may comprise a power switch, and the control circuit is adapted to adjust the conductivity of the switch, or adjust a difference between an amplitude of the input voltage to the converter and an amplitude of the output voltage of the converter according to the temperature of the battery sensed by the sensor.

These measures may be used to control the heat dissipation from the power switch, and thereby control the heat generation, and in turn, transfer from the converter to the battery. It is known that a large difference between the input voltage and output voltage of a converter causes a low efficiency and hence large power loss. Traditionally, this large difference is to be avoided to improve the efficiency. However, an embodiment of the invention actively adjusts this difference to obtain an efficiency that can be deliberately lower than the optimum efficiency of the converter, so as to produce more heat generation.

The battery may comprise a plurality of cells and the converter may be adapted to charge the battery, and the control circuit is adapted to select a series connection or a parallel connection of the cells so as to tune the input voltage or output voltage of the converter.

The series or parallel connection of the cells provides a simple way to make a large change in the converter input voltage (when discharging the battery) or output voltage (when charging the battery) and hence alter the converter efficiency.

The converter for example comprises a switched mode power supply having a power switch, and the control circuit is adapted to control a switching behavior of the converter according to the temperature of the battery sensed by the sensor.

A switched mode converter is a commonly used component of a battery charging system, and the switching behavior influences the efficiency of the converter. By tuning the switching behavior of the switched mode converter, the heat generation of the converter can be tuned.

The control circuit is for example adapted to tune a switching frequency of the converter.

The switching frequency influences the thermal loss of a power switch, and this can be altered without needing to change the input or output voltages. For example, normally the power switch is capable of operating with an optimum efficiency in a frequency range, but if it is manipulated at a higher frequency out of the range, its efficiency drops. This embodiment deliberately sets the switch to operate beyond its optimum frequency range so as to increase the heat generation for heating the battery.

The control circuit is for example adapted to:

increase a switching frequency of the converter if the temperature of the battery sensed by the sensor is below a first threshold, and

decrease a switching frequency of the converter if the temperature of the battery sensed by the sensor is above a second threshold.

In this way, the switching frequency is altered to actively control the heat generation when the sensed temperature reaches upper or lower threshold limits.

The limits are for example 10 degrees Celsius and 35 degrees Celsius, or any smaller range. The lower threshold is for example between 10 and 23 degrees and the upper threshold is for example between 25 and 35 degrees.

The control circuit may be adapted to tune the switching frequency of the converter according to a change of the amplitude of the input voltage so as to maintain the temperature of the battery. In this way, in case of variations in input voltage of the converter such as cloud shading on the solar panel, the conversion ratio of the converter and the efficiency of the converter changes. The switching behavior of the switch is then controlled to compensate for the efficiency change due to the changed conversion ratio and to provide a constant thermal energy generation, and in turn, transfer to the battery, so that the temperature of the battery remains stable.

The control circuit may be adapted to control the switched mode power supply to operate in a soft switching mode or in a hard switching mode according to the temperature of the battery sensed by the sensor.

Different soft and hard switching modes of operation of a switched mode power supply have different efficiencies. The soft switching mode, in which the switch is turned on and off when there is no or small current/voltage across the switch, also known as resonance mode, has high efficiency whereas a hard switching mode, in which the switch is turned on and off when there is substantial current through or voltage across the switch, results in lower efficiency and greater heat loss.

For example, the control circuit may be adapted to control the switched mode power supply to operate:

in a hard switching mode if the temperature of the battery sensed by the sensor is below a first threshold; and

in a soft switching mode if the temperature of the battery sensed by the sensor is above a second threshold.

In this way, the switching mode is altered to provide different heat generation of the converter to the battery when the sensed temperature of the battery reaches upper or lower threshold limits.

The control circuit may be further adapted to control an amplitude of a switch current into the power switch of the converter according to the temperature of the battery sensed by the sensor, thereby to alter the level of thermal heat generation, and in turn, transfer from the converter to the battery.

The power loss is determined based on the product of the current and voltage at the power switch. Thus, increasing the switch current can also increase the power loss.

The control circuit is for example adapted to control the converter to reach the peak power of a maximum power point tracking of a source that supplies to the converter before controlling the switching frequency of the converter, and the control circuit is adapted to control the switching frequency of the converter to increase the level of thermal heat generation, and in turn, transfer from the converter to the battery, after the converter reaches the peak power.

Maximum power point tracking is for example used for processing the power output of a solar panel. This power output will drop if the current is not at the maximum power point current. Therefore, it is preferable to reach the maximum power point first, and if the heating is still not at a desired level, to proceed to increase the switching frequency.

The converter and the battery may be placed within a thermally insulated chamber, such that the transfer from the converter to the battery is guaranteed. There may also be an air recirculation device within the thermally insulated chamber to recirculate air between the converter and the battery. This can provide better heat distribution from the converter to the battery within the same chamber.

The invention also provides a battery system comprising a battery and a battery control system as defined above.

The invention also provides a solar power system comprising:

a set of solar cells; and

a battery system as defined above for storing energy delivered by the set of solar cells into the battery.

The invention also provides a battery charge control method comprising:

charging or discharging a battery using a converter, wherein the converter and the battery are thermally coupled;

sensing the temperature of the battery; and

controlling the efficiency or power loss of the converter in dependence on the sensed temperature of the battery thereby to alter the level of thermal heat generation, and in turn, transfer from the converter to the battery.

The charging or discharging for example makes use of a converter which comprises a power switch, and the method comprises adjusting:

the conductivity of the switch;

an amplitude of the input voltage to the converter;

an amplitude of the output voltage of the converter;

a switching frequency of the converter; or

a ratio between the output voltage and the input voltage.

The charging or discharging for example makes use of a switched mode power supply and the method comprises operating the converter in a soft switching mode (for low heat generation) or in a hard switching mode (for high heat generation).

The battery may comprise a plurality of cells and the method comprises selecting a series connection or a parallel connection of the cells during battery charging so as to tune the output voltage of the converter.

These and other aspects of the invention will be apparent from and elucidated with reference to the embodiment(s) described hereinafter.

### BRIEF DESCRIPTION OF THE DRAWINGS

Examples of the invention will now be described in detail with reference to the accompanying drawings, in which:

FIG. 1 shows a battery control system used within a luminaire having solar energy charging;

FIG. 2 shows one possible example of the converter used in the system of FIG. 1;

FIG. 3 shows that if the frequency increases of a converter increases, the switching loss increases;

FIG. 4 shows the effect of a change in the input voltage on the conversion efficiency; and

FIG. 5 shows current versus voltage and power versus voltage plots to explain the maximum power point tracking function.

### DETAILED DESCRIPTION OF THE EMBODIMENTS

The invention provides a battery control system which is used with a battery, and has a converter to charge and/or discharge the battery. The converter is thermally coupled to the battery, and the temperature of the battery is sensed. A control circuit is provided for controlling the efficiency or power loss of the converter according to the temperature of the battery sensed by the sensor, thereby to alter the level of thermal heat generation, and in turn, transfer from the converter to the battery. In this way, the battery temperature is controlled so that the life time of the battery can be extended. It makes use of the existing converter to deliver thermal energy, so that a separate heater is avoided. The controller circuit is preferably for controlling the efficiency or power loss of the converter with the premise of: maintaining an input power of the converter when charging the battery; or maintaining an output power of the converter when discharging the battery. The premise means that: when charging the battery, the changed heat generation of the converter does not result from a change in the input power but results from the efficiency of the converter; when discharging the battery, the changed heat generation of the converter does not result from a change in the output power but results from the efficiency of the converter.

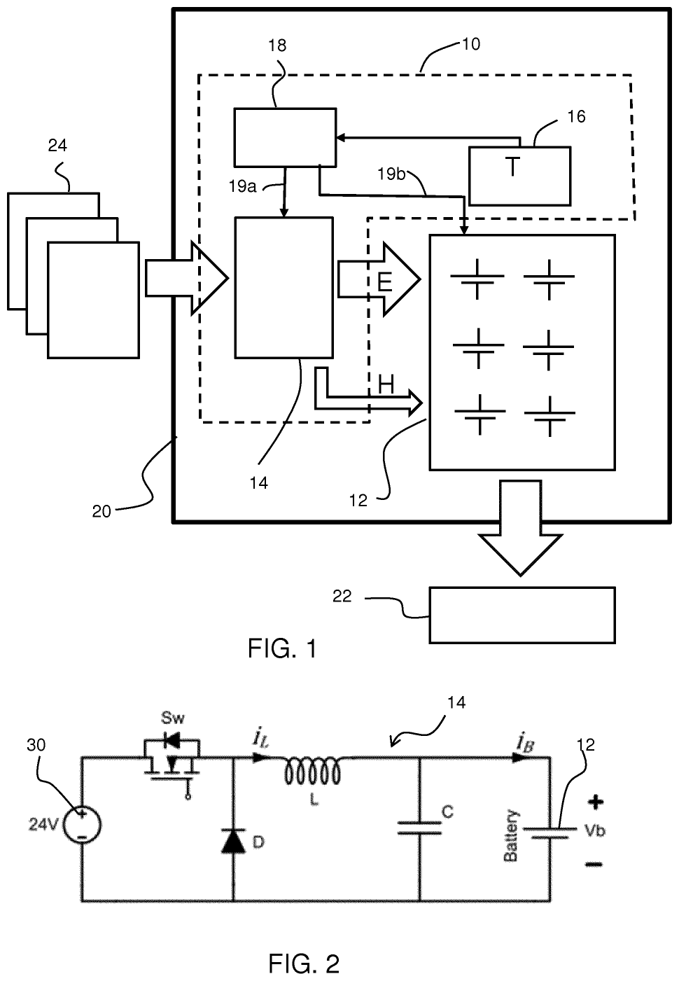

FIG. 1 shows a battery control system 10 to be used with a battery 12. The system 10 comprises a converter 14 to charge or discharge the battery 12, wherein charging is shown in the arrow with the reference sign E (for “electrical energy transfer”), and the converter is thermally coupled to the battery. Thus, heat generated by the converter as a result of inefficiency of the electrical conversion process is transferred at least partially to the battery 12, as shown in the arrow with the reference sign H (for “heat transfer”).

A temperature sensor 16 is provided for sensing the temperature of the battery 12, wherein a temperature T as shown is obtained.

A control circuit 18 is used to control the efficiency or power loss of the converter 14 according to the temperature of the battery sensed by the sensor 16, thereby to alter the level of thermal heat generation, and in turn, transfer from the converter 14 to the battery.

In this way, the temperature of the battery may be controlled by controlling the heat generation, and in turn, heat transfer from a converter. The converter for example has different modes of operation with different efficiency and hence different generation of excess heat. The change in efficiency does not change the main conversion purpose or goal of the converter in converting the source power or in driving the load. In other words, the source power output to the converter to the battery (when the battery is charged) does not change, or the power output from the converter to the load (when the battery discharges) does not change. Thus, the solar panel may still output its maximum power thus the solar power is best utilized; or the load is still driven at the desired power and there is no influence to the user experience. By controlling the mode, the battery may be maintained at a suitable temperature or in a particular temperature range, which is of particular importance during charging. In this way, the life time (in terms of the number of charging cycles) of the battery may be improved.

The battery temperature may for example be maintained above 10 degrees Celsius, for example between 10 degrees Celsius and 35 degrees Celsius, or between 15 degrees Celsius and 35 degrees Celsius. The most suitable temperature for battery charging is for example 23 to 25 degrees Celsius.

FIG. 1 shows that the battery control system 10 and the battery 12 are provided in an enclosure 20 so that the heat transfer between the converter 14 and the battery is optimized.

In one example, the battery 12 and its battery control system 10 are for providing energy to a light source 22 and for receiving energy from a solar cell array 24. The battery control system 10, battery 12 and light source 22 together define a luminaire with integrated battery. In street lighting applications, control system 10 and battery 12 can be a single system, whereas the light source 22 and solar cell array 24 can be separate systems. The solar energy is used to charge the battery via the converter 14, under the control of the control circuit 18, and to discharge the battery to the light source 22 via the same converter 14 preferably, again under the control of the control circuit 18. In this case the converter 14 may be a bi-directional converter that both charges and discharges the battery. Alternatively, two converters can be used respectively for charging and discharging the battery, and at least one of the two converters can be controlled by the control circuit 18 to change the efficiency of the converter.

Optionally, when the battery is fully charged and excess solar energy is received, energy may also be provided back to the energy grid, in known manner. The battery stores energy so that lighting may be provided when no solar energy is received.

FIG. 2 shows one possible example of the converter 14, in the form of a buck converter battery charger.

The buck converter is a DC-to-DC power converter which steps down the voltage while stepping up the current from its input (supply) to its output (battery). The circuit is a switched mode power supply having a diode and a transistor and an energy storage element in this example in the form of an inductor L. It should be noted that other type of converters are also applicable.

The converter is for example designed to charge a 12V battery from 24V power supply 30. The circuit comprises a main power switch Sw which controls the connection of the power supply 30 to the inductor L. A current i_{L} flows through the inductor and charges the load, in the form of a smoothing capacitor C in parallel with the battery 12. A freewheeling diode D enables the current to continue to flow when the power switch is turned off. A charging current i_{B} is delivered to the battery.

The power switch is operated at a switching frequency, for example in the kHz range. In one part of the cycle, energy is stored in the inductor and in the other part of the cycle energy is dissipated to the battery.

The power switch will for example operate nearly at 50% PWM duty cycle to regulate the voltage and current for the battery charging. Due to the hard switching regime, there will be some overlap between the switching voltage and current which causes the switching loss in the converter.

There are various ways to change the way the converter is controlled to alter the conversion efficiency and hence alter the generation of thermal energy.

A first approach is based on frequency control. For this purpose, the control circuit 18 provides a control signal 19a to the converter 14.

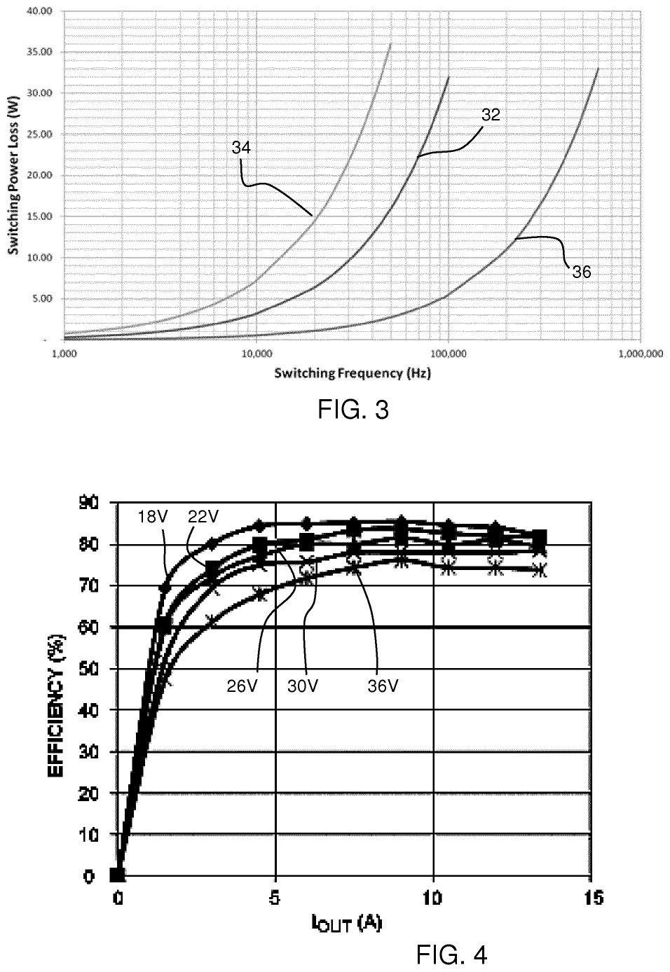

If the frequency increases, the switching loss in a switched mode power supply increases because more switching voltage and current waveforms overlap (per unit time). The duty cycle of the switch will be substantially constant. This is shown in FIG. 3, which plots the switching power loss as a function of switching frequency. Three plots are shown for different buck converter technologies; based on a MOS power switch (plot 32), an IGBT power switch (plot 34) and a GaN power switch (plot 36).

During the cold season, when the battery temperature may for example drop below 15 degrees Celsius, the converter can operate at a higher frequency to generate heat to heat up the battery.

The heat generation originates in the power switch Sw, and the power switch is usually connected to a heat sink which then dissipates the heat out of the converter 14 (out of the housing of the converter 14 if it has a housing) and into the enclosure 20, so that the heat can reach and be directly utilized by the closely placed battery 12. In a real product, the battery can be attached to the housing of the converter 14. Any passive or active way of transferring the heat to the battery is applicable.

The switching frequency of the converter may be increased if the temperature of the battery sensed by the sensor is below a first threshold, and may be decreased if a switching frequency of the converter if the temperature of the battery sensed by the sensor is above a second threshold.

In this way, the switching frequency is altered when the sensed temperature reaches upper or lower threshold limits. This limits the amount of adjustment needed to the switching frequency while keeping the temperature within a desired range.

Under the above condition, it may preferable to try to maintain a constant temperature when the input voltage (and hence the required conversion ratio) may vary. For example, as a cloud moves in the sky, the solar panel may be shaded or not shaded from time to time, thus the solar panel voltage varies. It is needed to maintain the heat generation of the converter to maintain the battery's temperature. The switching frequency of the converter may be adjusted according to a change of the amplitude of the input voltage so as to maintain the temperature of the battery. In this way, variations in input voltage are used to control the converter behavior so that the heat generation and the battery's temperature remains stable. These input voltage variations may be characteristic of the input energy source, such as solar energy.

A second approach is based on conversion ratio control. Again, this may be governed by control signal 19b.

For example, the controller may adjust a difference between an amplitude of the input voltage to the converter and an amplitude of the output voltage of the converter according to the temperature of the battery sensed by the sensor. This change in voltage results in a different conversion ratio, and different pulse width modulation signal. This in turn influences the conversion efficiency.

FIG. 4 shows the effect of a change in the input voltage of the converter. The conversion efficiency (%) is plotted against the output current for five different input voltages. When there is a higher voltage difference between the input and output, higher switching losses arise in the converter due to increased overlap between voltage and current. wherein, the curve noted by diamonds is for 18V input voltage; square for 22V input voltage; triangle for 26V input voltage; x for 30V input voltage; and asterisk for 36V input voltage.

In the case of multi-stage cascaded connected power converters, the front converter output can vary which is input to the following converters.

In another example, in discharging the battery, the input voltage to the converter 14 is the battery's output voltage, and the output voltage is the LED's forward voltage. By switching the battery's series/parallel connection, the input voltage of the converter can be tuned.

When the input voltage is derived from a solar cell system, the solar voltage will fluctuate in dependence on the solar insolation. Typically, from morning to afternoon the solar voltage goes up then starts coming down. This means when temperatures are typically lower (when there is lower insolation), the power loss is greater, so that a partial self-regulation takes place during the day. The solar current will also fluctuate. Thus, current regulation of solar based battery charging is also able to regulate the heat generation.

A third approach is based on controlling the conductivity of the power switch. Again, this may be governed by control signal 19a. Lower conductivity will result in increased losses across the switch.

In bipolar junction transistor power switches, by applying different a bias current (Ib) the conductivity can be changed. For a MOSFET power switch, the on-state resistance also changes with different gate voltages.

A fourth approach is based on control of the load. For this purpose, a control signal 19b is provided. The battery will have a set operating voltage. However, if the battery comprises a plurality of cells (as shown schematically in FIG. 1) the control circuit 14 may then select between a series connection or a parallel connection of the cells so as to tune the output voltage of the converter. Thus, the set battery voltage can be changed based on the series-parallel combination of cells. There may be two settings (all parallel or all series) or multiple settings combining series and parallel branches.

The series or parallel connection of the cells provides a simple way to make a large change in the converter output voltage and hence alter the converter efficiency, by creating high input and output voltage differences.

A fifth approach is based on controlling the amplitude of the switch current into the power switch of the converter in dependence on the temperature of the battery sensed by the sensor. Again, this may be governed by control signal 19a. The power loss is determined based on the product of the current and voltage across the power switch. Thus, increasing the switch current can also increase the power loss.

The switch current control is for example suitable for solar maximum power point operation, or any other operation where the input supply has almost constant voltage but the current varies with time.

Based on this embodiment, controlling the current through the switch can contribute to the control of the heat generation.

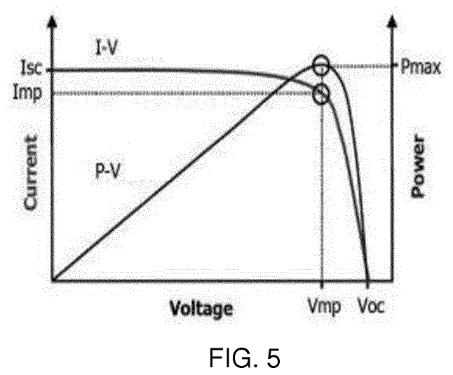

FIG. 5 shows current versus voltage (“I-V”) and power versus voltage (“P-V”) plots to explain the maximum power point tracking function.

Vmp and Imp represent the solar system voltage and solar cell current at the maximum power point Pmax. Voc is the open circuit voltage and Isc is the short circuit current. In the maximum power point tracking, the solar system output voltage increases, and so increases the output power of the solar cell, until the point Pmax is reached. Once the voltage of the solar system exceeds Vmp corresponding to the maximum power Pmax, the controller detects that the output power drops, and the controller instructs each conversion unit to decrease its voltage. Finally the system will be stable around Vmp and Pmax.

As the solar incident intensity changes with time throughout the day or due to cloud cover, the maximum power point Pmax will change, and the system dynamically moves to the new Vmp and Pmax point.

To best utilize the solar energy, it is preferable to make the converter reach the maximum power point of the solar panel first, and then if the heat of the converter is still not at a desired level, to proceed to increase the switching frequency. More specifically, when using a maximum power point tracking converter to generate the heat, before starting to tune the switching frequency, the control circuit is for example adapted to control the converter to tune its input current and input voltage to reach the peak power of the solar panel, before controlling the switching frequency of the converter. If converter at the peak power is already enough for making the converter generate (and transfer) the required heat, there is no need to tune the switching frequency out of the optimum scope. When the peak power point operation of the source (i.e. solar cell array) is already present, but the battery's temperature is still not high enough, the control circuit is then adapted to control the switching frequency of the converter to increase the level of thermal heat generation, and in turn, transfer from the converter to the battery.

A sixth approach is based on selecting a switching mode. Again, this may be governed by control signal 19a.

A switched mode power supply may operate in a hard switching mode or a soft switching mode. Hard switching occurs when there is an overlap between voltage and current when switching the transistor or on and off. This overlap causes energy loss as explained above.

Soft switching begins with one electrical parameter set to zero (current or voltage) before the switch is turned on or off. This has benefits in terms of low losses. The smooth resonant switching waveforms also minimize EMI.

Thus, these two switching modes have different power loss. The control circuit may thus control the switched mode power supply to operate in a soft switching mode or in a hard switching mode according to the temperature of the battery sensed by the sensor.

For example, the control circuit may be adapted to control the switched mode power supply to operate in a hard switching mode if the temperature of the battery sensed by the sensor is below a first threshold and in a soft switching mode if the temperature of the battery sensed by the sensor is above a second threshold.

The resonance soft switching mode may be used for highest power efficiency for battery charging only, whereas the hard switching mode may be used for heat generation only (for fast heating) or for heat generation and battery charging at the same time. The system can thus switch between these different modes in dependence on the heating needs and the battery charging needs.

The switching mode may be altered when the sensed temperature reaches upper or lower threshold limits. This limits the amount of adjustment needed to the switching mode while keeping the temperature within a desired range. If further heat is required even when in the hard switching mode, the other measures outlined above may be employed in addition like a hard switching with large current in high frequency, even with large difference in input voltage and output voltage.

The invention is of particular interest to battery integrated indoor and outdoor lighting systems or solar street lighting applications. However, it is of more general application to systems with integrated batteries and a battery charging and discharging circuit, wherein the battery may be exposed to extreme temperatures.

The example of a buck converter has been given above. However, the converter may be a boost converter, a buck-boost converter, a push-pull converter, a forward converter, or a half-bridge or full bridge inverter.

The battery and the converter within the enclosed chamber may be further equipped with a fan for better heat distribution around the battery and the converter. The generated heat is thus not lost to the environment as it will be within a closed chamber.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A battery control system to be used with a battery comprising:
a converter to charge and/or discharge the battery, wherein the converter is adapted to thermally couple to the battery; and
a sensor to sense the temperature of the battery,
wherein the system further comprises a control circuit to control the efficiency or power loss of the converter according to the temperature of the battery sensed by the sensor, thereby to alter the level of thermal heat generation, and in turn, transfer from the converter to the battery; and
wherein the converter comprises a switched mode power supply having a power switch, and the control circuit is adapted to control a switching behavior of the converter according to the temperature of the battery sensed by the sensor, wherein the control circuit is adapted to control the switched mode power supply to operate in a soft switching mode or in a hard switching mode according to the temperature of the battery sensed by the sensor, wherein the current and/or voltage across the switch during the soft switching mode is lower than the current and/or voltage across the switch during the hard switching mode.

2. A battery control system as claimed in claim 1, wherein the control circuit is to control the efficiency or power loss of the converter with the premise of:
maintaining an input power of the converter when charging the battery; or
maintaining an output power of the converter when discharging the battery.

3. A battery control system as claimed in claim 1, wherein the control circuit is further adapted to adjust the conductivity of the switch, or adjust a difference between an amplitude of the input voltage to the converter and an amplitude of the output voltage of the converter according to the temperature of the battery sensed by the sensor.

4. A battery control system as claimed in claim 3, wherein the battery comprises a plurality of cells and wherein the converter is adapted to charge the battery, and the control circuit is adapted to select a series connection or a parallel connection of the cells so as to tune the input voltage or output voltage of the converter.

5. A battery control system as claimed in claim 1, wherein the control circuit is adapted to tune a switching frequency of the converter.

6. A battery control system as claimed in claim 5, wherein the control circuit is adapted to:
increase a switching frequency of the converter if the temperature of the battery sensed by the sensor is below a first threshold, and
decrease a switching frequency of the converter if the temperature of the battery sensed by the sensor is above a second threshold.

7. A battery control system as claimed in claim 5, wherein the control circuit is adapted to tune the switching frequency of the converter according to a change of the amplitude of the input voltage so as to maintain the temperature of the battery.

8. A battery control system as claimed in claim 1, wherein the control circuit is adapted to control the switched mode power supply to operate:
in a hard switching mode if the temperature of the battery sensed by the sensor is below a first threshold; and
in a soft switching mode if the temperature of the battery sensed by the sensor is above a second threshold.

9. A battery control system as claimed in claim 1, wherein the control circuit is further adapted to control an amplitude of a switch current into the power switch of the converter according to the temperature of the battery sensed by the sensor, thereby to alter the level of thermal heat generation, and in turn, transfer from the converter to the battery.

10. A battery control system as claimed in claim 5, wherein the control circuit is adapted to control the converter to reach at a peak power in a maximum power point tracking of a source that supplies to the converter before controlling the switching frequency of the converter, and
the control circuit is adapted to control the switching frequency of the converter to increase the level of thermal heat generation, and in turn, transfer from the converter to the battery after the converter reaches the peak power.

11. A battery control system as claimed in claim 1, wherein the converter and the battery are placed within a thermally insulated chamber, and the system further comprises an air recirculation device within the thermally insulated chamber to recirculate air between the converter and the battery.

12. A battery system comprising a battery and a battery control system as claimed in claim 1.

13. A solar power system comprising:
a set of solar cells; and
a battery system as claimed in claim 13 for storing energy delivered by the set of solar cells into the battery.

14. A battery charge control method comprising:
charging or discharging a battery using a converter, wherein the converter and the battery are thermally coupled;
sensing the temperature of the battery; and
controlling the efficiency or power loss of the converter in dependence on the sensed temperature of the battery thereby to alter the level of thermal heat generation, and in turn, transfer from the converter to the battery;
wherein the converter comprises a switched mode power supply having a power switch, and controlling the efficiency or power loss of the converter comprising to control a switching behavior of the converter according to the temperature of the battery sensed by the sensor, wherein controlling a switching behavior of the converter comprising to control the switched mode power supply to operate in a soft switching mode or in a hard switching mode according to the temperature of the battery sensed by the sensor, wherein the current and/or voltage across the switch during the soft switching mode is lower than the current and/or voltage across the switch during the hard switching mode.
